(19) United States
(12) Patent Application Publication
(10) Pub. No.: US 2019/0323866 A1
(43) Pub. Date: Oct. 24, 2019

(54) Surface Mounting Device for a Sensor Package

(71) Applicant: Aurora Flight Sciences Corporation, Manassas, VA (US)

(72) Inventor: Andrew Heafitz, Manassas, VA (US)

(21) Appl. No.: 15/957,163

(22) Filed: Apr. 19, 2018

(51) Int. Cl. G01D 11/30

(52) U.S. Cl. CPC G01D 11/30; B64C 39/024

(57) ABSTRACT

A surface mounting device is disclosed. The mounting device may be configured for coupling to a sensor package. The mounting device may include an active adherent and one or more passive adherents. The active adherent may include a suction cup with a powered pressurizer in fluid communication with a cavity of the suction cup. The passive adherent(s) may include one or more pads having an adhering coating. The mounting device may be positioned proximate a suitable mounting surface by a vehicle, such as an aerial vehicle. Once proximate a suitable surface, the mounting device may first attach itself to the surface using the active adherent. The mounting surface may attach itself to the surface using the passive adherent(s) if a more permanent attachment is desired, and/or if power is in short supply.

### TECHNICAL FIELD

The present disclosure relates to a surface mounting device, and more particularly to a surface mounting device configured to attach a sensor package to a surface for observation.

### BACKGROUND

Sensors are often attached to surfaces to observe a surrounding environment. For instance, visual, and/or audio sensors (e.g., cameras and/or microphones) may be mounted in/on elevators, offices, building exteriors, homes, retail stores, etc. Other sensors may also be useful for various purposes in varying environments. For example, barometric sensors may be used in outdoor environments for weather forecasting, and/or seismic sensors may be used for early earthquake detection. These sensors may be helpful for a wide range of scientific, security, and/or civilian personnel, in all sorts of environments (e.g., urban, rural, underground, elevated, etc.) and situations. However, placement of the sensors in an ideal position for observation may sometimes be a challenge. Therefore, a need exists for a surface mounting device, and more particularly, a surface mounting device configured to attach a sensor package to a surface for observation.

### SUMMARY

The present disclosure relates to a surface mounting device, and more particularly to a surface mounting device configured to attach a sensor package to a surface for observation.

According to a first aspect, a mounting device for securing a sensor payload at an object comprises: a base configured to support the sensor payload; a suction cup coupled to a first surface of the base, the suction cup defining a cavity that is in fluid communication with a pressurizer, wherein the pressurizer is configured to create a negative pressure within the cavity to adhere the suction cup to a mounting surface of the object; a controller operatively coupled to the pressurizer, the controller configured to selectively activate the pressurizer to achieve a predetermined negative pressure within the cavity; and a release valve configured to vent the cavity, thereby releasing the suction cup from the mounting surface of the object.

In certain aspects, the mounting device further comprises a check valve positioned in line between the pressurizer and the cavity, wherein the check valve is configured to maintain the predetermined negative pressure within the cavity when the pressurizer is inactive.

In certain aspects, the fluid relief passage includes a release valve configured to regulate pressure is positioned in line between the pressurizer and the cavity via the fluid relief passage, and.

In certain aspects, the release valve is operatively coupled to the controller, the controller being configured to actuate the release valve to releases the suction cup from the mounting surface of the object.

In certain aspects, the controller is operatively coupled with a pressure sensor configured to measure the negative pressure within the cavity.

In certain aspects, the controller is operatively coupled to the release valve, the controller being configured to actuate the pressurizer or the release valve as a function of a measurement from the pressure sensor.

In certain aspects, the suction cup comprises a gasket that is configured to conform to a shape or a texture of the mounting surface, thereby providing a fluid-tight seal between the suction cup and the mounting surface.

In certain aspects, the gasket is fabricated from a pliable material.

In certain aspects, the suction cup and the gasket are fabricated as a single unitary structure from a pliable material.

In certain aspects, the suction cup is fabricated from a rigid structure and the gasket is fabricated from a pliable material.

In certain aspects, the sensor package comprises at least one sensor configured to observe a surrounding environment.

In certain aspects, the at least one sensor is configured to determine a position of the mounting device within the surrounding environment.

In certain aspects, the at least one sensor comprises a camera, a motion sensor, a position sensor, a proximity sensor, a pressure sensor, or an accelerometer.

In certain aspects, the sensor package is communicatively coupled with a second sensor package in via a network.

In certain aspects, the mounting device further comprises a coupling configured to couple releasably the mounting device to an aerial vehicle.

In certain aspects, the vehicle is an aerial vehicle.

In certain aspects, the base comprises a hub that is configured to interface with the sensor package, wherein the hub is removably attached to the base and configured to interface with a sensor package.

In certain aspects, the mounting device further comprises a passive adherent coupled to the first surface of the base, wherein the passive adherent is configured to adhere the mounting device to the mounting surface via the base.

In certain aspects, the passive adherent comprises a plurality of adhesive pads.

In certain aspects, the pressurizer is coupled to a power source, wherein the controller is configured to adhere the mounting device to the mounting surface via the suction cup or the passive adherent based at least in part on a status of the power source.

According to a second aspect, a method for securing a sensor payload at an object using a mounting device comprises: positioning at a mounting surface a base configured to support the sensor payload, wherein a suction cup is coupled to a first surface of the base, the suction cup defining a cavity that is in fluid communication with a pressurizer; creating, via a pressurizer, a negative pressure within the cavity to adhere the suction cup to the mounting surface of the object; and selectively activating, via a controller, a pressurizer to achieve a predetermined negative pressure within the cavity.

In certain aspects, the method further comprises the step of releasing the suction cup from the mounting surface of the object via a release valve configured to vent the cavity.

In certain aspects, the method further comprises the step of determining, via one or more sensors coupled to the controller, whether the mounting device is proximate the mounting surface, wherein the negative pressure within the cavity is generated if the mounting device is proximate the mounting surface.

In certain aspects, the method further comprises the step of determining, via the controller, whether the mounting device is positioned at a suitable position based at least in part on surveillance data acquired by the sensor package, wherein the mounting device is adhered to the mounting surface using a passive adherent if the mounting device is positioned at a suitable position.

In certain aspects, the mounting device is adhered to the mounting surface using the passive adherent by applying negative pressure to the cavity via the pressurizer to compress the suction cup until the passive adherent is brought into adhering contact with the mounting surface.

In certain aspects, the passive adherent comprises one or more adhesive pads.

In certain aspects, the passive adherent is positioned within the cavity.

In certain aspects, the mounting device is positioned proximate the mounting surface using an unmanned aerial vehicle.

According to a third aspect, a surveillance system comprises: a first mounting device configured to secure a first sensor payload to a first mounting surface, wherein the first mounting device comprises: a base configured to support the first sensor payload: a suction cup coupled to a first surface of the base, the suction cup defining a cavity that is in fluid communication with a pressurizer, wherein the pressurizer is configured to create a negative pressure within the cavity to adhere the suction cup to the first mounting surface; a controller operatively coupled to the pressurizer, the controller configured to selectively activate the pressurizer to achieve a predetermined negative pressure within the cavity; and a release valve configured to vent the cavity, thereby releasing the suction cup from the first mounting surface; a second mounting device configured to secure a second sensor payload to a second mounting surface, wherein the second mounting device comprises: a base configured to support the second sensor payload: a suction cup coupled to a second surface of the base, the suction cup defining a cavity that is in fluid communication with a pressurizer, wherein the pressurizer is configured to create a negative pressure within the cavity to adhere the suction cup to the second mounting surface; a controller operatively coupled to the pressurizer, the controller configured to selectively activate the pressurizer to achieve a predetermined negative pressure within the cavity; and a release valve configured to vent the cavity, thereby releasing the suction cup from the second mounting surface; and an aerial vehicle configured to place the second mounting device at the second mounting surface based at least in part on information from the first sensor payload.

In certain aspects, the vehicle is an unmanned aerial vehicle.

### DESCRIPTION OF THE DRAWINGS

The foregoing and other objects, features, and advantages of the devices, systems, and methods described herein will be readily understood from the following description of particular embodiments thereof, as illustrated in the accompanying figures, where like reference numbers refer to like structures. The figures are not necessarily to scale, emphasis instead being placed upon illustrating the principles of the devices, systems, and methods described herein.

FIG. 1a illustrates a front perspective view of an example mounting device according to an aspect of the present disclosure.

FIG. 1b illustrates a bottom plan view of the example mounting device of FIG. 1a.

FIG. 1c illustrates a top plan view of the example mounting device of FIG. 1a.

FIG. 1d illustrates a front cross section view of the example mounting device of FIG. 1c, along line 1d-1d.

FIG. 2 illustrates a block diagram illustrating a component architecture of an example sensor package.

FIG. 3 illustrates a block diagram illustrating functional relationships between component architectures of an example sensor package, an example mounting device, and a remote device.

FIGS. 4a through 4d show various aerial vehicles that may be used to engage and place the example mounting device of FIG. 1.

FIG. 5a illustrates an example method of placing the example mounting device on a surface using an aerial vehicle.

FIG. 5b illustrates an example environment with multiple mounting devices and sensor packages.

FIGS. 6a through 6c illustrate the example mounting device of FIG. 1, with varying levels of suction cup compression.

FIG. 7 illustrates a block diagram illustrating an example method of operation of the example mounting device of FIG. 1.

### DETAILED DESCRIPTION

Preferred embodiments of the present disclosure will be described herein below with reference to the accompanying drawings. The components in the drawings are not necessarily drawn to scale, the emphasis instead being placed upon clearly illustrating the principles of the present embodiments. For instance, the size of an element may be exaggerated for clarity and convenience of description. Moreover, wherever possible, the same or similar reference numbers are used throughout the drawings to refer to the same or like elements of an embodiment. In the following description, well-known functions or constructions are not described in detail because they may obscure the disclosure in unnecessary detail. Further, it is understood that terms such as “first,” “second,” “top,” “bottom,” “upper,” “under,” “lower,” “side,” “front,” “back,” and the like, are words of convenience and are not to be construed as limiting terms. No language in the specification should be construed as indicating any unclaimed element as essential to the practice of the embodiments. For this application, the following terms and definitions shall apply:

The terms “about” and “approximately,” when used to modify or describe a value (or range of values), position, orientation, and/or action, mean reasonably close to that value, range of values, position, orientation, and/or action. Thus, the embodiments described herein are not limited to only the recited values, ranges of values, positions, orientations, and/or actions but rather should include reasonably workable deviations.

The terms “aerial vehicle” and “aircraft” refer to a machine capable of flight, including, but not limited to, fixed-wing aircraft, unmanned aerial vehicles (UAVs), variable wing aircraft, and/or vertical take-off and landing (VTOL) aircraft.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “communicate” and “communicating” refer to (1) transmitting, or otherwise conveying, data from a source to a destination, and/or (2) delivering data to a communications medium, system, channel, network, device, wire, cable, fiber, circuit, and/or link to be conveyed to a destination.

The terms “coupled,” “coupled to,” and “coupled with” as used herein, each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect,” means to attach, affix, couple, join, fasten, link, and/or otherwise secure. As used herein, the term “anchor” means to attach, affix, connect, couple, join, fasten, link, and/or otherwise secure.

The term “data” as used herein means any indicia, signals, marks, symbols, domains, symbol sets, representations, and any other physical form or forms representing information, whether permanent or temporary, whether visible, audible, acoustic, electric, magnetic, electro-magnetic, or otherwise manifested. The term “data” is used to represent predetermined information in one physical form, encompassing any and all representations of corresponding information in a different physical form or forms.

The term “exemplary” means serving as a non-limiting example, instance, or illustration. As utilized herein, the terms “e.g.,” and “for example” set off lists of one or more non-limiting examples, instances, or illustrations.

The term “memory” means computer hardware or circuitry to store information for use by a processor and/or other digital device. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

The term “operatively coupled” means that a number of elements or assemblies are coupled together, such that as a first element/assembly moves from one state (and/or configuration, orientation, position etc.) to another, a second element/assembly that is operatively coupled to the first element/assembly also moves between one state (and/or configuration, orientation, position etc.) to another. It is noted that a first element may be “operatively coupled” to a second element without the opposite being true.

The term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, or integrated with a memory device.

Disclosed herein are examples systems and methods to alleviate the problem of attaching a sensor package (or other packages) to a surface. In some situations, it may be desirable to attach a sensor package at a difficult-to-reach position. For example, it may be desirable to attach a sensor package to a wall at a height that is difficult to reach without assistance, but that may otherwise be ideal for observation (e.g., via the sensor package). Similarly, it may be desirable to attach a sensor package to a surface that is accessible, but with no readily available means of securement. For example, the surface may be a moving surface, or a surface that is located in a windy and/or otherwise turbulent environment. The surface may be a vertical surface, a sheer surface, an inclined surface, a horizontal surface, or a combination thereof.

The present disclosure addressing the foregoing by attaching a sensor package to a surface (e.g., a building exterior, wall, or other mounting surface) using a vehicle. Suitable vehicles include aerial vehicles (e.g., UAVs), ground vehicles (e.g., unmanned ground vehicles (UGVs)), and/or aquatic vehicles (e.g., unmanned aquatic vehicles). Accordingly, while much of the following disclosure contemplates using an aerial vehicle, it should be understood that other vehicles may be used, including, inter alia, aquatic and/or ground vehicles.

To facilitate attachment of the sensor package to a surface, the sensor package may be coupled to (or integrated with) a mounting device that is configured for mounting to a desired surface for an extended period. The mounting device may also be repositionable to enable the mounting device to be adjusted or relocated. For example, the mounting device may be adjusted or relocated when the mounting device is mounted incorrectly, when it is desirable to relocate the mounting device to a more suitable position (or surface), etc. Generally speaking, a powered device (i.e., an active adherent) can deplete a power supply over an extended period of time and an adhesive attachment mechanism (i.e., a passive adherent) alone may lose its adherent power (i.e., adhesiveness) if it is repeatedly removed and/or reattached during repositioning of the mounting device. Therefore, the present disclosure provides a mounting device that can employ both active and passive adherents to attach a sensor package (or another package or payload) to a surface more reliably. Accordingly, a mounting device in accordance with the present disclosure may be repositioned as needed (e.g., at least for a limited time period) before establishing a more permanent attachment when it is determined that the mounting device (and/or sensor package) is positioned at an acceptable location.

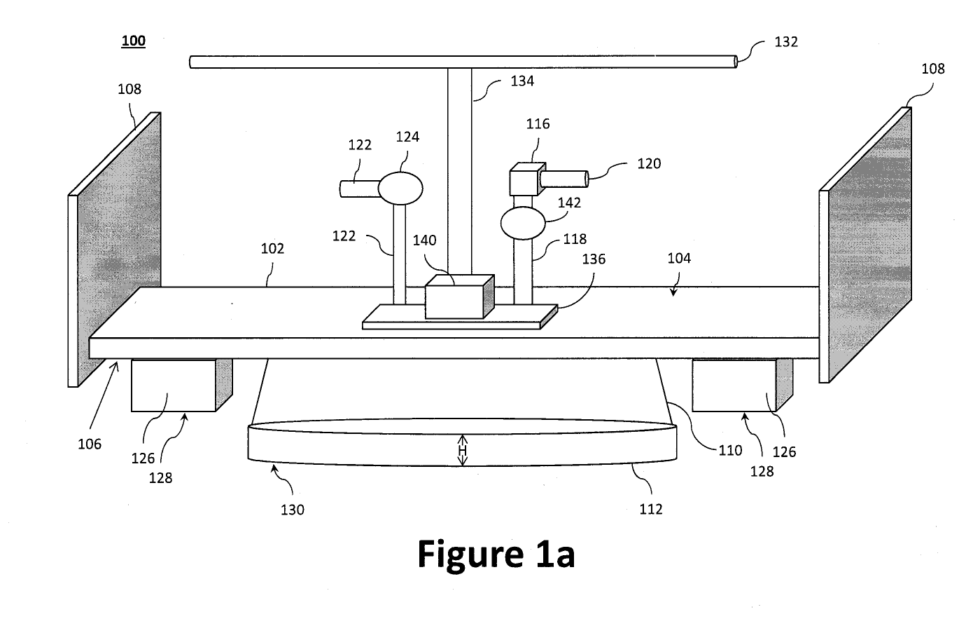

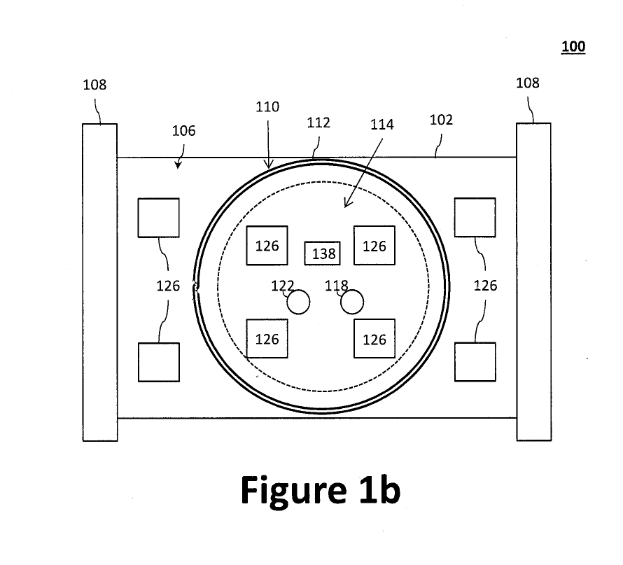

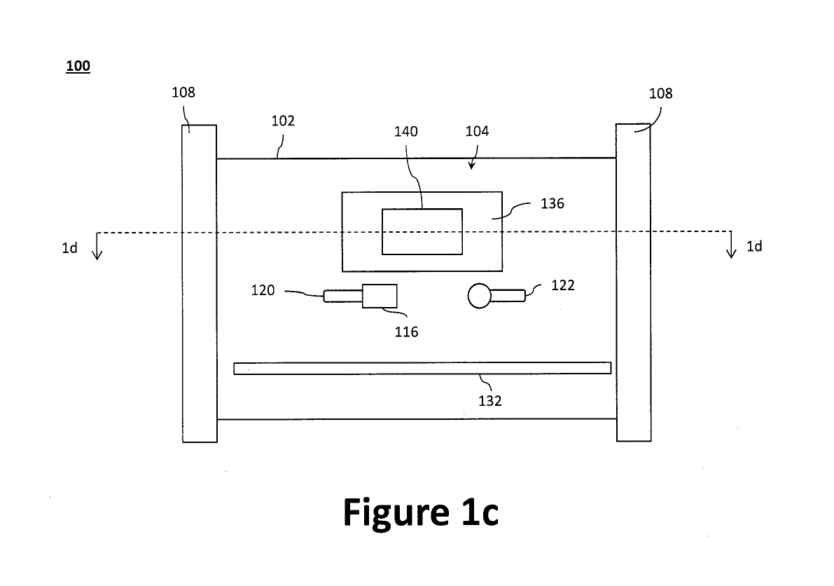

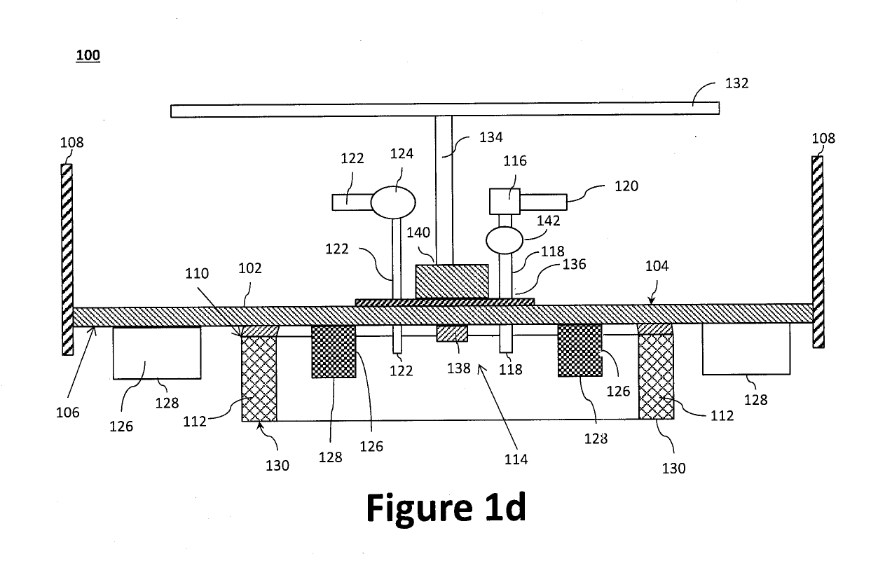

FIG. 1a illustrates a front perspective view of an example mounting device 100. The mounting device 100 may include a base 102 (e.g., a chassis, a frame, or another structure). The base 102 may be formed as a polyhedron, such as a cube or rectangular box. In other examples, the base 102 may be formed into a different type of polyhedron, such as a prism, an octahedron, etc. In some examples, the base 102 may be formed as another three-dimensional solid, such as a cylinder or a sphere, for example. The base 102 may include an topside surface 104 and an underside surface 106 that is opposite and opposing the topside surface 104. As illustrated, each of the topside surface 104 and/or the underside surface 106 may be generally flat, level, planar, and/or may be formed with a polygon profile, such as a rectangle. In other examples, each of the topside surface 104 and/or the underside surface 106 may be curved. In certain aspects, some surfaces may be curved while others may be generally flat, level, planar, and/or formed in a polygon profile.

The mounting device 100 may include one or more vehicle couplings configured to facilitate coupling of the mounting device 100 to a vehicle, such as an aircraft (e.g., UAV), automobile, truck, train, boat hull, etc. In the example mounting device 100 of FIGS. 1a through 1d, the vehicle couplings may be provided via one or more walls 108, which may be attached to the sides of the base 102. However, other vehicle couplings are contemplated, including snaps, clips, magnets, hooks, hook-and-loop fasteners, etc. As shown in FIGS. 1a through 1d, the walls 108 may be formed as thin polyhedrons—namely rectangular boxes or plates. However, in other examples, the walls 108 may be formed as different types of polyhedrons, or as other three-dimensional solids. In certain aspects, the walls 108 may serve as bulwarks and arranged to protect the components of the mounting device 100 and/or sensor package 140 (e.g., from damage during transport and/or from ground personnel).

In some examples, the walls 108 may be fabricated from a thin high-strength rigid material such that the walls 108 approximate two-dimensional objects (e.g., thin plates). In some examples, the planar outward facing surfaces of walls 108 may be configured to be gripped, pressed, grasped, and/or otherwise engaged by an aerial vehicle, thereby facilitating attachment of the mounting device 100 to the aerial vehicle. In some examples, the walls 108 may be formed with corners, knurls, grooves, protrusions, hooks, apertures, magnets, and/or other features to improve attachment to the aerial vehicle.

Once coupled to the mounting device 100, the vehicle may position the mounting device 100 proximal a mounting surface, such as a wall, a window, a roof, a floor, a table, a ceiling, a shelf, a sign, a lamp, a rock, a tree, a vehicle, and/or some other suitable structure. In certain aspects, the mounting device 100 may be attached to a vehicle (moving or stationary) and used to track the vehicle's location or activities.

The temporary attachment between the mounting device 100 and vehicle could be selectively released (e.g., automatically or via a command from a remote device) upon establishing a trigger condition. Releasing the mounting device 100 may allow the vehicle to deposit a sensor package 140 in a new location. For example, the mounting device 100 may be released if the vehicle reaches a point of interest, if the vehicle was leaving the surveillance area to allow the sensor to be recovered, etc. Once proximate to a mounting surface, the mounting device 100 may activate its pressurizer and suction onto the mounting surface. Then the vehicle may depart, leaving the mounting device 100 anchored to the mounting surface, with sensor package 140 in tow. One or more sensors (e.g., position sensors, proximity sensors, pressure sensors, etc.) of the sensor package 140 may detect and/or determine how well the suction cup 110 is attached to the mounting surface, such as a wall. For example, the sensor may measure displacement of the suction cup 110 or the gasket, which may act as a spring, with displacement proportional to vacuum pressure. Alternatively, or additionally, the one or more sensors may measure pressure within the cavity 114 of the suction cup 110.

The mounting device 100 may include both an active adherent and a passive adherent 126 to anchor the mounting device 100 to a mounting surface. The active adherent may employ, for example, a suction cup 110 that defines a cavity 114, which may be in fluid communication with a vacuum pump 116 (or another form of pressurizer, such as a vacuum reservoir). Therefore, as illustrated, the mounting device 100 may employ a suction cup 110 as the active adherent, though other active adherents are contemplated (e.g., electromagnets). In some examples, the cavity 114 may be in fluid communication with the vacuum pump 116, which may be powered by the power source of the sensor package 140, and/or powered by an independent power source of the mounting device 100. Suitable power sources include batteries, solar panels, or a combination thereof.

The suction cup 110 may be fabricated from a soft, pliable material, such as rubber, plastic, silicone, vinyl, neoprene, etc. The suction cup 110, which can be coupled to the underside surface 106 of the base 102, may be shaped along its perimeter (e.g., around a hollow interior of the suction cup 110) to define a gasket 112. The gasket 112 can conform to a shape or a texture of the mounting surface, thereby providing a fluid-tight (e.g., airtight, watertight, etc.) seal between the cavity 112 of the suction cup 110 and the mounting surface. Therefore, in certain aspects, the suction cup 110 and the gasket 112 may be fabricated as a single unitary structure from a pliable material. Accordingly, a cavity 114 may exist within the interior of the suction cup 110 that can be sealed against a mounting surface by the gasket 112. In some examples, the suction cup 110 and/or the gasket 112 may be shaped as a ring (e.g., circular or oval). In operation, the suction cup 110 may compress against the mounting surface when the vacuum is formed within the cavity 114 of suction cup 110.

While the suction cup 110 is described as pliable, the suction cup 110 may instead be formed from a rigid material (e.g., metal or hard plastic bell-shaped structure) whereby the gasket 112 is fabricated from a soft, pliable material that can be adhered to the perimeter of the suction cup 110 (here, a rigid suction cup, for example). Therefore, the suction cup 110 and the gasket 112 may be fabricated as different structures and coupled to one another, where the suction cup 110 may be fabricated from a rigid structure, while the gasket 112 may be fabricated from a pliable material. According to this aspect, the gasket 112 may be configured, in operation, to compress against a mounting surface when the vacuum is formed within the cavity 114 of suction cup 110. For example, the gasket 112 may be compressible, such that a height H of the gasket 112 may vary depending on (among other things) the pressure within the cavity 114.

A conduit 118 may fluidly couple the vacuum pump 116 to the cavity 114 of the suction cup 110, such that fluid (e.g., gas, air, water, etc.) may be pumped by the vacuum pump 116 in to and/or out of the cavity 114 via the conduit 118. In some examples, a check valve 142 may be positioned in the conduit 118 in line with the vacuum pump 116, so as to maintain negative pressure within the cavity 114 when the vacuum pump 116 is inactive (e.g., deactivated so as to save power). The vacuum pump 116 may have an inlet/outlet pipe 120 through which to take in and/or expel fluid (e.g., to or from a reservoir or the environment, depending on the fluid type). While a single conduit 118 and/or pipe 120 is shown in the Figures, in some examples, a plurality of conduits 118 and/or pipes 120 may be used. The vacuum pump 116 may be powered by a power source (e.g., of the mounting device 100 and/or of the sensor package 140), as discussed below.

In operation, the vacuum pump 116 may actively maintain the predetermined level of suction by being cycled on and off, and/or being throttled to compensate for any leakage by monitoring how well the suction cup 110 is attached to the mounting surface. If the mounting device 100 and/or sensor package 140 is positioned on a smooth surface, such as a glass pane, any leakage may be nominal; therefore, the package may maintain suction without requiring action by the vacuum pump 116. However, if the mounting device 100 is on a rough surface, such as concrete or brick, the vacuum pump 116 may have to be activated more frequently to maintain the predetermined suction level.

The cavity 114 of the suction cup 110 may also be in fluid communication with a relief passage 122 and a release valve 124, which may be configured to selectively open and close the relief passage 122. When opened, the relief passage 122 allows the pressure within the cavity 114 to equalize with the ambient pressure (e.g., the surrounding environment), thereby removing the suction force of the suction cup 110. In other words, the relief passage 122 provides a path for fluid to enter/exit the cavity 114, so as to equalize the fluid pressure in the cavity 114 with the fluid pressure of the surrounding environment. The pressure equalization may reduce the adhering force of the suction cup 110 and help to release the mounting device 100 from any mounting surface to which the suction cup 110 may have anchored. The relief passage 122 may be opened and/or closed through an actuation of the release valve 124. The actuation of the release valve 124 may be manually conducted, which may be accomplished locally (e.g., by a person) or remotely (e.g., by the UAV that positions and/or repositions the mounting device). In some examples, the release valve 124 may include an automatic actuation mechanism configured to actuate the release valve 124 in response to commands from a processor. The controller may communicate commands to the release valve 124 in the form of electrical signals to open and/or close the relief passage 122 via the release valve 124. In some examples, the release valve 124 may be biased to close the relief passage 122 in the absence of any contrary actuation and/or command.

The mounting device 100 may further include one or more passive adherents 126 coupled to an underside surface 106 of the base 102. The passive adherents 126 are unpowered mechanisms configured to adhere the mounting device 100 to a mounting surface. Suitable passive adherents 126 include permanent magnets (e.g., high-strength magnets, such as rare earth magnets, including neodymium (NdFeB) magnets) and/or pads (or other structures) coated with adhesives, glues, tapes, etc. The passive adherents 126 may be positioned on an underside surface 106 of the mounting device 100, within the cavity 114 defined the suction cup 110, outside the cavity 114 of the suction cup 110, proximate to the suction cup 110, or in another desired position. In some examples, the passive adherents 126 may be coupled to the base 102 around the suction cup 110, such as at equidistant positions around the base 102 (such as shown in FIG. 1b, for example). In some examples, one or more passive adherents 126 may be coupled to the base 102 within the cavity 114 of the suction cup 110 (such as shown in FIG. 1b, for example). In any event, the passive adherents 126 may be positioned such that they remain spaced from the mounting surface while the suction cup 110 is attached to the mounting surface, but may be moved into contact with the mounting surface by significantly compressing the suction cup 110 (e.g., through an increased negative pressure differential applied by the vacuum pump 116). While four passive adherents 126 are illustrated as positioned around the outside of the suction cup 110 and two passive adherents 126 are illustrated as positioned within the cavity 114 of the suction cup 110, any desired number of passive adherents 126 may be used to achieve a desired bond strength. For example, a heavier mounting device 100 or sensor package 140 may warranted additional passive adherents 126.

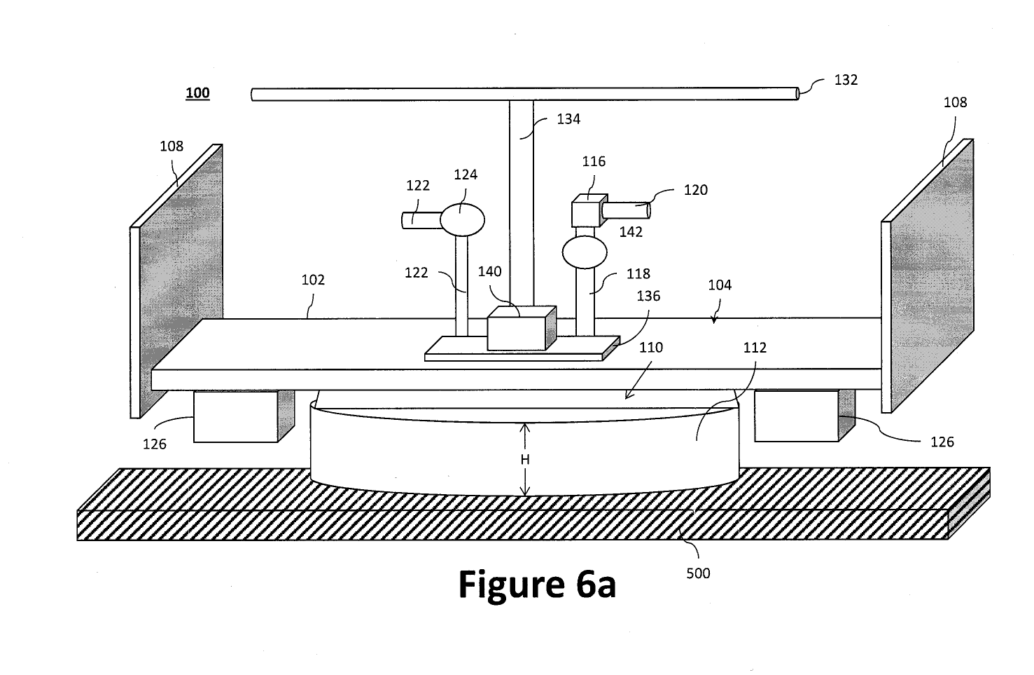

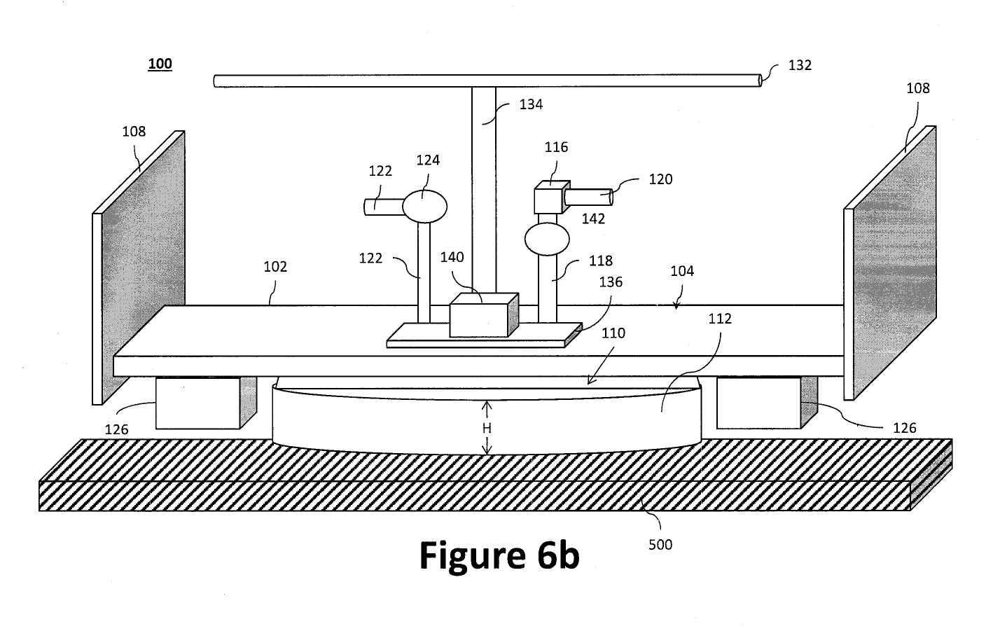

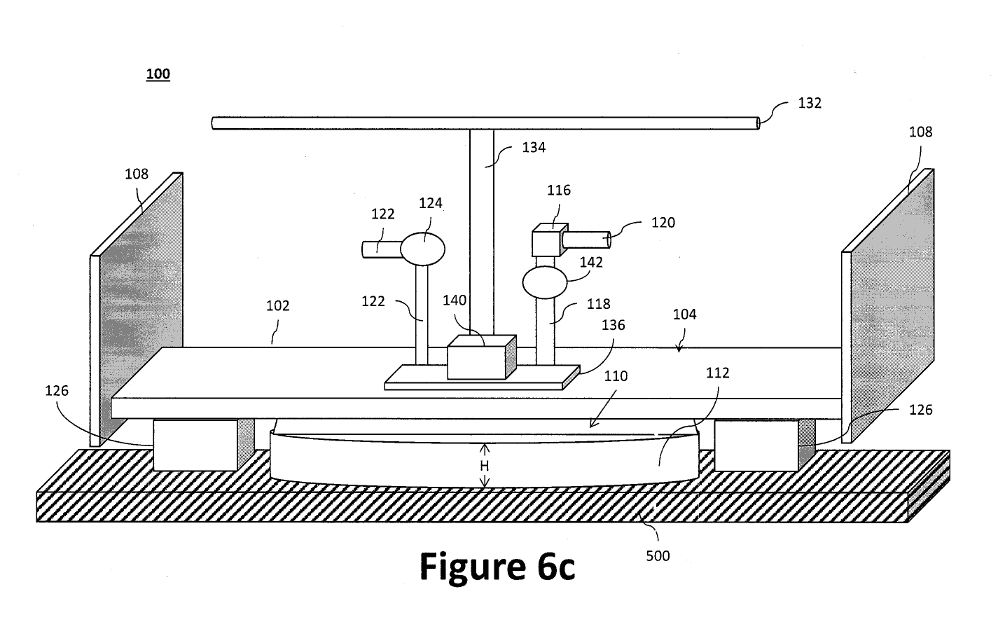

The passive adherents 126 may be positioned such that the passive adherents 126 are spaced from a mounting surface when the edge 130 of the gasket 112 is in contact with the mounting surface and the gasket 112 is fully uncompressed (such as shown in FIG. 6a, for example). The passive adherents 126 may be positioned such that the passive adherents 126 are also spaced from a mounting surface when the edge 130 of the gasket 112 is in contact with the mounting surface and the gasket 112 is partially compressed (such as shown in FIG. 6b, for example). However, the passive adherents 126 may be positioned such that the passive adherents 126 come into contact with, and/or adhere to, a mounting surface when the edge 130 of the gasket 112 is in contact with the mounting surface and the gasket 112 is significantly (and/or severely, fully, etc.) compressed (such as shown in FIG. 6c, for example). Thus, by severely compressing the gasket 112 and/or the suction cup 110 (i.e., via negative pressure created in the cavity 114 by the vacuum pump 116), the passive adherents 126 may be brought into adhering contact with a mounting surface, so as to attach the mounting device 100 to the mounting surface via the passive adherents 126.

By attaching the mounting device 100 to the mounting surface with the passive adherents 126, the active adherent of the mounting device 100 (i.e., the suction cup 110 and vacuum pump 116) may be disabled (e.g., turned off) without causing the mounting device 100 to lose its attachment to the mounting surface. In certain aspects, the vacuum pump 116 may maintain the vacuum when shut off (e.g., via a valve) or it may release the pressure in the cavity 114. In some examples, the passive adherents 126 may be actuated to come into contact with and/or adhere to the mounting surface. In this example, a controller may operate the position of the passive adherents 126 with respect to the mounting surface upon receiving a signal to mount the mounting device 100 to the mounting surface.

The mounting device 100 may further include an antenna 132 (e.g., to enable wireless communication), which may be coupled to the base 102 via a stanchion 134. In some examples, the stanchion 134 may also be electrically conductive, so as to assist in the function of the antenna 132 and/or conduct electrical signals between the antenna 132 and a transceiver. While illustrated in FIGS. 1a through 1d as a simple stanchion 134 and crossbar, in other examples, the antenna 132 may be formed in a variety of different configurations in order to better facilitate reception and/or transmission of wireless signals. In some examples, the antenna 132 and/or stanchion 134 may also be used as a vehicle coupling. For example, the antenna 132 and/or stanchion 134 may serve as a structure through which a vehicle may be coupled to the mounting device 100. In some examples, the antenna 132 and/or stanchion 134 may be reinforced to ensure sufficient strength and stability to function as a vehicle coupling (e.g., able to support the weight of the mounting device 100 when suspended by the antenna 132 and/or stanchion 134. In some examples, the mounting device 100 may include multiple antennas 132 and/or stanchion 134.

While a wireless approach is illustrated, a wired approach may be used. For example, the sensor package 140 could communicate by a wire that is spooled (reeled in or out) between the sensor package 140 and another location (e.g., another sensor, a delivery UAV that may be positioned at a nearby location, a base station, etc.). The sensor package 140 could communicate directly to a base station or form part of a network of communicating devices. The sensor package 140 could also be a communications relay for other sensors or users.

In some examples, the mounting device 100 may include a hub 136 configured to be operatively coupled to a sensor package 140. The hub 136 may be secured to the topside surface 104 of the base 102 through one or more mechanical attachment means (e.g., bolts, screws, soldering, welding, etc.). In some examples, the hub 136 may be configured for removable attachment to the base 102, such as through a magnetic attachment mechanism, hook fasteners, fabric hook-and-loop fasteners (e.g., Velcro®, available from DuPont), snap fasteners, bolts/screws, a snap fit arrangement, a frictional fit arrangement, and/or other suitable means. The removable attachment may allow the entire hub 136 to be removed from one mounting device 100 and/or attached to another mounting device (while the sensor package 140 is attached to the hub 136, for example).

Alternatively, rather than releasing the hub 136, removing the sensor, and leaving the suction cup, the passive adherents 126 may be detached. The passive adherents 126 may be detached with a release mechanism, with hook-and-loop fasteners, or by overpowering the passive adherents 126, thereby causing the connection between the passive adherents 126 and the mounting surface (or the underside surface 106) severed. Similarly, a frangible element may be provided within the passive adherents 126 (e.g., at a foam center of a double stick pad).

If the device mounting device 100 is removed by releasing/breaking a permanent mount, another set of passive adherents 126 (each having an adhering surface 128) may be provided that are further recessed to allow a second permanent mounting. For example, compressing the suction cup 110 to a first level may cause the first set of passive adherents 126 to engage the mounting surface, while further compressing the suction cup 110 to a second level may cause a second set of passive adherents 126 to engage the mounting surface in the absence of the first set of passive adherents 126. In another aspect, the passive adherents 126 may extend after they are engaged, either passively or actively, so that the adhering surface 128 need not fight in tension against the compressive force of the suction cup 110 after the pressure has bled off In yet another aspect, with reference to FIG. 6c, instead of the suction cup 110 being completely compressed (e.g., by increasing the vacuum within the cavity 114), the passive adherents 126 could actively extend to engage the mounting surface. The passive adherents 126 may include, inter alia, glue or tape, or an active element like a screw anchor.

In some examples, a sensor 138 may be positioned within the cavity 114 of the suction cup 110. In some examples, the sensor 138 may be coupled to the underside surface 106 of the base 102. In some examples, the sensor 138 may be coupled to the hub 136 and/or the sensor package 140. The sensor 138 may be configured to detect and/or determine displacement and/or compression of the suction cup 110 (and/or gasket 112), which may act as a spring when negative pressure is applied within the cavity 114 of the suction cup 110. Displacement and/or compression may be measured, for example, by measuring a distance (and/or change in distance) between the sensor 138 and the base 102, between the sensor 138 and a mounting surface, and/or between the sensor 138 and the edge 130 of the gasket 112. In some examples, the sensor 138 may infer and/or indirectly measure displacement and/or compression of the suction cup 110 (and/or gasket) by measuring the fluid pressure within the cavity 114 of the suction cup 110. In some examples, the sensor 138 may be part of the hub 136 of the mounting device 100. In some examples, the sensor 138 may be part of the sensor package 140.

While a suction cup 110 is primarily described, other active adherents/attachment devices are contemplated. For example, the suction cup 110 may be replaced with an electromagnet for attaching to ferrous (metallic) structures, such as cars, boats, bridges etc. Accordingly, the passive attachment may be a permanent magnet. Because the electromagnet may not be modulated to control the distance, the permanent magnets may be moved relative to the mounting device 100. In certain aspects, a magnetic base may be turned on or off.

The sensor package 140 may be in operation over time once anchored to a suitable surface. For example, the sensor package 140 may communicate data representative of its observations (i.e., data of its environment) to one or more remote devices. Alternatively, or additionally, the sensor package 140 may store the data in a local memory. A determination may be made by the sensor package 140 controller and/or one or more of the remote devices as to whether the sensor package 140 is in an advantageous position for its operation. The determination may be based at least in part on the observations made by the sensor package 140 during the time the sensor package 140 was in an anchored state.

If it is determined that the sensor package 140 is not in an advantageous position or an otherwise desired position, the vehicle may return and couple itself to the mounting device 100 and/or sensor package 140. Once the vehicle is coupled, the negative pressure within the cavity 114 of the suction cup 110 may be released by actuating the release valve 124 and opening the relief passage 122. Opening the relief passage 122 removes the suction force (i.e., vacuum) of the suction cup 110; thereby allowing the vehicle to move the mounting device 100 and/or sensor package 140 to another mounting position where the mounting process may begin anew. However, if the sensor package 140 is determined to be in a good position, the vacuum pump 116 may continue to actively maintain sufficient suction until power source of the vacuum pump 116 begins to near a threshold (e.g., a low battery threshold).

The amount of time needed to mount the mounting device 100 to a mounting surface can vary based on a number of factors, including, without limitation, the leakage rate (e.g., via the gasket 112), the type of power source, the capacity of the power source, the type of mounting surface, the vacuum pump 116, etc. Once the threshold is reached, or is sufficiently close, the vacuum pump 116 may turn on and/or increase suction so as to compress the suction cup 110 and gasket 112 more fully. Passive adherents 126 (e.g., adhesive pads) located at the base of the mounting device 100 and/or suction cup 110 may then be brought into contact with the mounting surface so as to affix the mounting device 100 and/or sensor package 140 to the mounting surface. Once the package is affixed, the vacuum pump 116 may be shut off and the package should remain in place indefinitely without using any further power.

The vacuum pump 116 and suction cup 110 driven active adherent may be used to attach the mounting device 100 using a power source to the mounting surface. The likelihood of the sensor package 140 needing to be repositioned may decrease with time, such that the power source may be needed in the beginning only, before either the sensor package 140 and/or mounting device 100 is repositioned, or a more permanent passive (i.e., unpowered) adherent is employed.

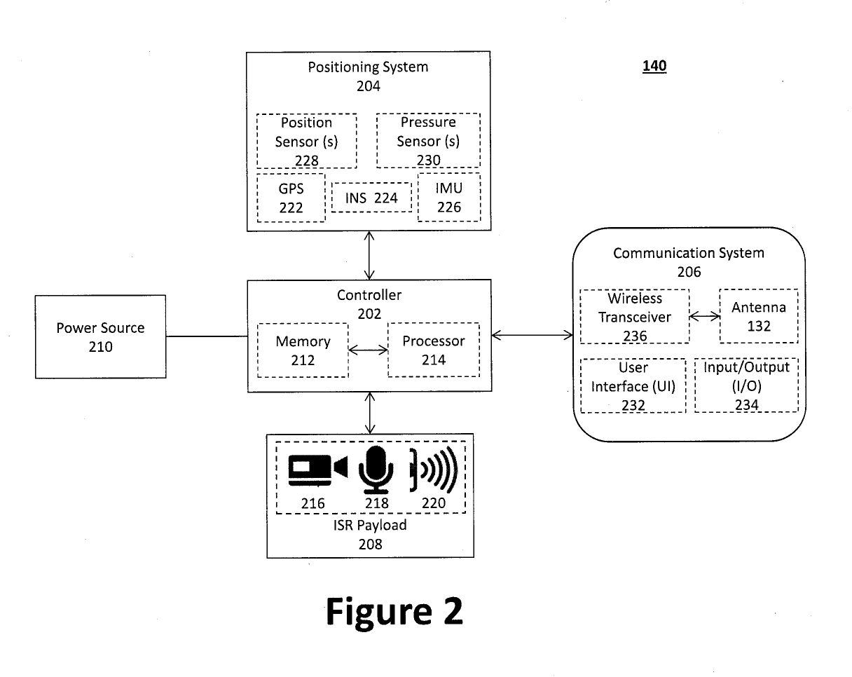

FIG. 2 illustrates a block diagram illustrating an example architecture for a sensor package 140. The sensor package 140 may include an intelligence, surveillance, and reconnaissance (ISR) payload and/or a positioning system 204. The sensor package 140 may further include a communication system 206 for communication with a user and/or other systems and/or devices. The sensor package 140 may also include a control system 202 having a processor 214 operatively coupled with memory 212. The control system 202 may be configured to coordinate operation of the sensor package 140 and/or the mounting device 100 when the sensor package 140 is coupled to the hub 136 of the mounting device 100. The sensor package 140 may additionally include a power source 210, such as one or more batteries, engines, photovoltaic (solar) cells, generators, and/or other suitable power sources. In some examples, some or the entire mounting device 100 may be powered through the power source 210 of the sensor package 140. In some examples, the sensor package 140 may draw power from a power source 210 of the mounting device 100 in addition to, or instead of, its own power source 210.

As noted above, the control system 202 may include a memory 212 and a processor 214, which may communicate with the various components of sensor package 140 a data bus. The processor 214 may be implemented as a microprocessor, for example, and may be configured to control and/or coordinate operation of the sensor package 140 based on information received from the various components of the sensor package 140. In some examples, the processor 214 may additionally, or alternatively, be configured to control and/or coordinate operation of the mounting device 100 when the sensor package 140 is coupled to the hub 136 (and/or some other appropriate interface) of the mounting device 100. The processor 214 may be used to control operation of the vacuum pump 116. For example, the processor 214 may communicate commands to the vacuum pump 116 in the form of electrical signals. The commands may instruct the vacuum pump 116 to start and/or stop, as well as provide instructions as to an amount of negative pressure or positive pressure to apply in/to the cavity 114.

The ISR payload 208 may comprise one or more devices configured to observe and/or interact with a surrounding environment, such as one or more optical sensors 216 (e.g., cameras, LIDAR, etc.), audio sensors 218 (e.g., microphones), audio speakers 220, motion detectors, pressure sensors, temperature sensors, position sensors, proximity sensors, an RF antenna/signal receiver, and/or other sensors. The one or more optical sensors 216 may be configured to receive and/or generate data representing one or more images of the surrounding environment. The image(s) may be still photos or videos, which generally comprises a series of still photos known as frames. In some examples, the ISR payload 208 may be used for surveillance of the surrounding area, and/or to help determine whether the sensor package 140 is placed in an opportune location for surveillance. Any video, image, audio, telemetry and/or other sensor data (“surveillance data”), collected by the ISR payload 208 may be locally stored in memory 212 and/or communicated in real time (and/or at a later time) via the communication system 206 to an operator, a remote device (e.g., a ground control station) and/or a vehicle (e.g., the mounting device 100 positioning vehicle). In some examples, the ISR payload 208 may be used to help determine characteristics of a mounting surface, so as to determine the effectiveness of the active and/or passive adherents, as well as determine potential and/or actual leakage from a seal effectuated between the suction cup 110 and the mounting surface.

Data pertaining to leakage of the suction cup 110 may be used to determine if and/or when to activate the vacuum pump 116, as well as an amount of vacuum pressure to apply to the cavity 114. Based on the data, the vacuum pump 116 may be cycled on and off, and/or throttled to compensate for any leakage.

The positioning system 204 may measure, detect, record, and/or otherwise observe a position of the sensor package 140 in relation to the surrounding environment. In some examples, the positioning system 204 may include a global navigation system (GPS) 222, an inertial navigation system 224 (INS), an inertial measurement unit (IMU) 226, one or more position sensors 228, and/or pressure sensor(s) 230. In some examples, the positioning system 204 may help to determine displacement and/or compression of the suction cup 110 (and/or gasket), which may act as a spring when negative pressure is applied within the cavity 114 of the suction cup 110.

Displacement may be determined, for example, by measuring the distance (and/or change in distance) between the sensor package 140 and the base 102, and/or the distance between the sensor package 140 and the edge 130 of the gasket 112. In some examples, the positioning system 204 may infer and/or indirectly measure displacement and/or compression of the suction cup 110 (and/or gasket 112) by measuring the pressure within the cavity 114 of the suction cup 110. In some examples, the pressure within the cavity 114 of the suction cup 110 may be compared to measured and/or known pressure of the surrounding environment. In some examples, one or more components of the positioning system 204 may instead be embodied in the ISR payload 208, and/or vice versa. In some examples, one or more components of the positioning system 204 may be used to operate the sensor 138, or replaced by the sensor 138.

The communication system 206 may comprise various components through which the sensor package 140 may communicate with other systems, devices, and/or operators. The communication system 206 may include a user interface (UI) 232, one or more input/output (I/O) connectors 234, and a wireless transceiver 236. The communication system 206 may further include an antenna 132, which the wireless transceiver 236 may use to help facilitate transmission and/or receipt of electrical signals.

The hub 136 may include one or more I/O connectors 234 configured to be operatively coupled to one or more complementary I/O connectors 234 of the sensor package 140. In some examples, the I/O connections may double as securement mechanisms between the sensor package 140 and the base 102. In some examples, the I/O connections may allow the sensor package 140 to facilitate control of some or the entire mounting device 100. In some examples, the I/O connections may be configured to allow the mounting device 100 to control some or the entire sensor package 140 and/or to monitor the observations of the sensor package 140. In some examples, the hub 136 may be omitted, and the sensor package 140 may be directly attached to the base 102. In certain aspects, the sensor package 140, the pump, and the valve may be located inside the suction cup 110, which may improve weatherproofing or packaging convenience.

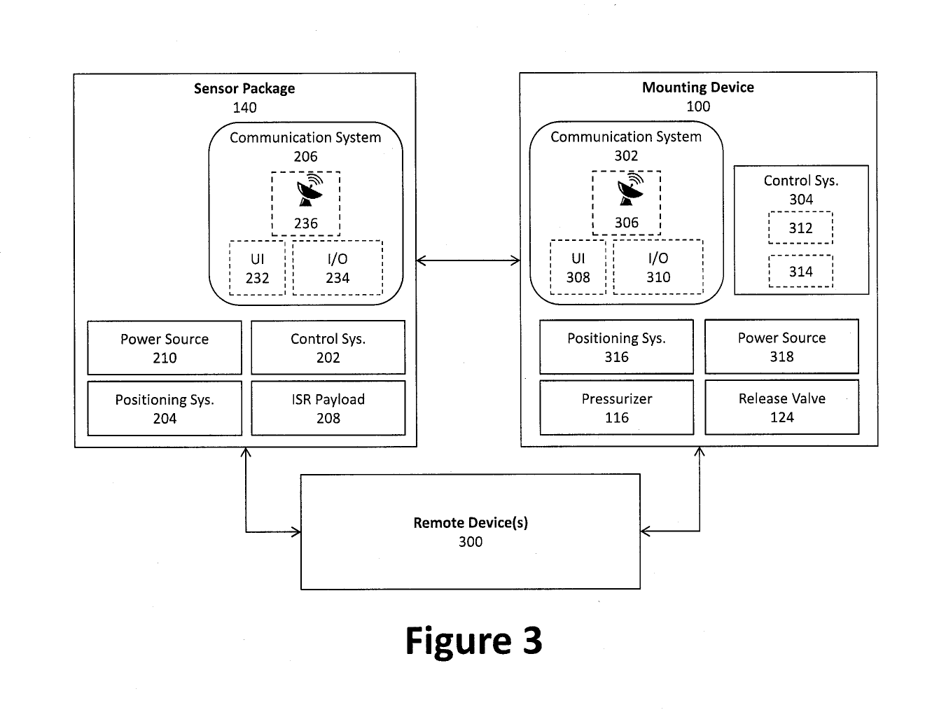

An operator may control some or all of the operation of the sensor package 140, and/or receive feedback from the sensor package 140, through the user interface 232. The user interface 232 may comprise input and/or output devices, such as a keyboard, a touch screen, a display, cameras, lights, and/or speakers. In some examples, a user interface 232 of the mounting device 100 (such as shown in FIG. 3, for example) may additionally, or alternatively, be configured to allow for operator control of all or some operation of the sensor package 140. In some examples, the user interface 232 of the sensor package 140 may be configured to control all or some operation of the mounting device 100. In certain aspects, the communications system may be used to communicate the status of the mounting device 100, such as the pressure in the suction cup 110, the state of charge of the power source 210, and information from the position sensors 228.

In some examples, the wireless transceiver 236 may be configured for wireless communication with other systems and/or devices. The wireless transceiver 236 may be operatively coupled to the antenna 132 to facilitate the communication. In some examples, the wireless transceiver 236 may be used to communicate with a remote device 300 (e.g., the mounting device 100, a ground control station, and/or a vehicle) to send and/or receive sensor data and/or instructions. For example, the wireless transceiver 236 may communicate surveillance data acquired by the ISR payload 208 with the vehicle that placed the mounting device 100 and/or an operator. The surveillance data may be used to determine whether the mounting device 100 and/or sensor package 140 is placed in a good position (such that the passive adherents 126 should be used for more permanent anchorage), and/or if the mounting device 100 and/or sensor package 140 should be repositioned.

The communication system 206 may further include one or more I/O connectors through which wired communication with other systems and/or devices may be facilitated. The I/O connectors 234 may include both male and female type connectors as appropriate. In some examples, the sensor package 140 may be coupled to the mounting device 100, such as with respect to the hub 136 of the mounting device 100, for example, via a wireless or wired connection through the I/O connectors 234. In some examples, the sensor package 140 may be coupled to a vehicle (e.g., a positioning vehicle) when the sensor package 140 and/or mounting device 100 is being positioned, so that the vehicle may take advantage of surveillance data acquired by the sensor package 140 during positioning. In some examples, the I/O connectors 234 may be configured for connection to third party devices (e.g., laptops, desktops, mobile phones, tablet computers, peripheral devices, memory sticks, and/or other devices).

FIG. 3 illustrates a block diagram illustrating potential interaction between the sensor package 140, mounting device 100, and/or one or more remote devices 300. In some examples, as shown in FIG. 3, the mounting device 100 may have a system architecture that is similar to the architecture of the sensor package 140. For example, the mounting device 100 may include a mounting-side control system 304 having a communications bus, a processor 314, and/or a memory 312. The mounting device 100 may further include a power source 318, a positioning system 316, and/or a mounting-side communication system 302. In some examples, the power source 318 used by the mounting device 100 may actually be the power source 210 of the sensor package 140, rather than its own independent power source. In some examples, the power source 210 used by the sensor package 140 may actually be the power source 318 of the mounting device 100, rather than its own independent power source. In some examples, the positioning system 316 of the mounting device 100 may help to determine displacement and/or compression of the suction cup 110 (and/or gasket 112) by, for example, measuring the distance (and/or change in distance) between the base 102 and the edge 130 of the gasket 112. In some examples, the positioning system 316 of the mounting device 100 may infer and/or indirectly measure displacement and/or compression of the suction cup 110 (and/or gasket 112) by measuring the pressure within the cavity 114 of the suction cup 110. In some examples, one or more components of the positioning system 316 may instead be embodied in the positioning system 204 of the sensor package 140, and/or vice versa. In some examples, one or more components of the positioning system 316 may be used to operate the sensor 138, or replaced by the sensor 138. Other sensors that may be used to measure the position of the suction cup 110 include, inter alia, limit switches, and/or tilt sensors.

In some examples, the mounting-side communication system 302 of the mounting device 100 may comprise a transceiver 306 and/or a user interface 308, similar to the communication system 206 of the sensor package 140. In some examples, the transceiver 306 of the mounting device 100 may also be coupled to the antenna 132. In some examples, the mounting device 100 and sensor package 140 may share transceivers and/or UIs, with one or both being embodied entirely within the sensor package 140 or the mounting device 100. The mounting-side communication system 302 of the mounting device 100 may also include one or more I/O connectors 310, similar to the I/O connectors 234 of the sensor package 140. The I/O connectors 310 of the mounting device 100 may be positioned, for instance in the hub 136, such that the I/O connectors 234 of the sensor package 140 and the I/O connectors 310 of the mounting device 100 operatively couple the sensor package 140 to the mounting device 100 when the sensor package 140 is coupled to the hub 136.

As discussed above, the mounting device 100 may include a release valve 124 and a vacuum pump 116. If the pump is self-sealing (or powered all the time), the pump could serve as both the pump and the check valve 142, where running the pump in reverse could serve as the release valve. The control system 202 of the sensor package 140 and/or the mounting-side control system 304 of the mounting device 100 may coordinate and/or control operation of the vacuum pump 116 and/or the release valve 124, based on information acquired, received, and/or generated by the sensor package 140 and/or mounting device 100.

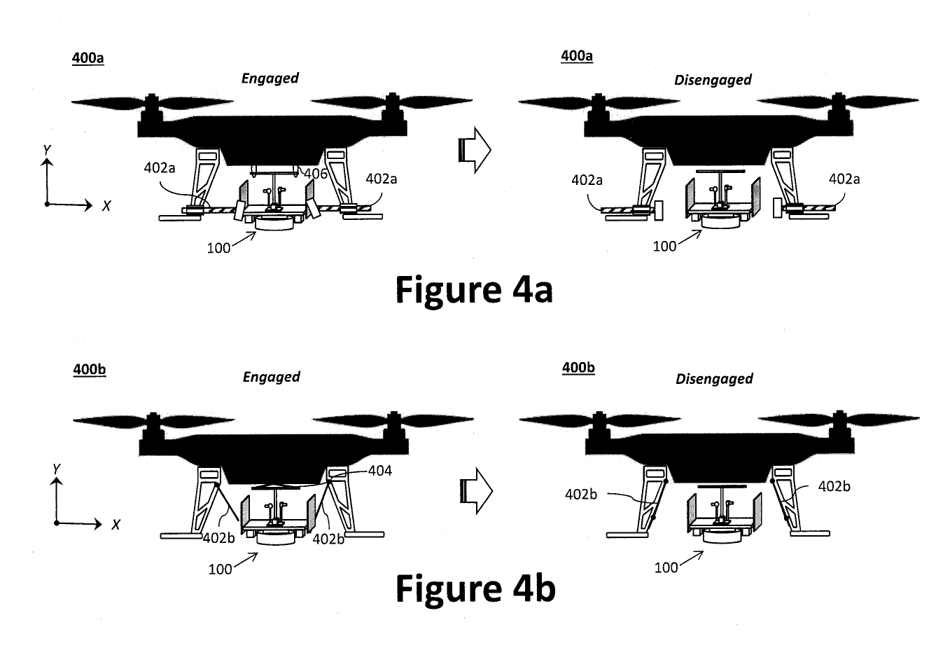

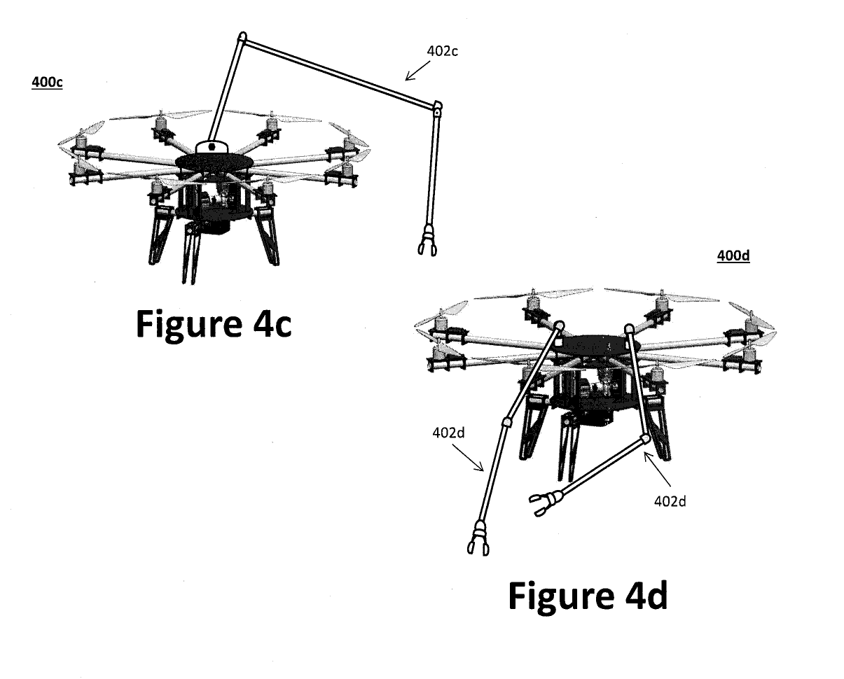

FIGS. 4a through 4c illustrate ways in which an example UAV 400 may grasp and/or engage the mounting device 100, using the vehicle couplings described above. As shown in FIGS. 4a through 4d, a UAV 400 may use moveable arms 402 to engage the mounting device 100. FIG. 4a illustrates a UAV 400a using laterally displaceable piston-type arms 402a to press against the walls 108 of the mounting device 100 from either side, so as to squeeze and/or pinch the mounting device 100 between the laterally displaceable piston-type arms 402a. FIG. 4b illustrates a UAV 400b having pivoting arms 402b that press against the walls 108 of the mounting device 100 from either side, so as to squeeze and/or pinch the mounting device 100 between the pivoting arms 402b. Additionally, one or more tethers 404 may be coupled to the antenna 132 to provide further support when engaged. FIGS. 4c and 4d show examples of UAVs 400c, 400d having articulating arms 402c, 402d with multiple joints and segments for greater degrees of freedom, as well as hands (or end effectors) that may be used to grasp, pick up, and/or manipulate objects (e.g., the mounting device 100 and/or sensor package 140). These and other methods may be used to grasp and/or otherwise engage a mounting device 100 and/or sensor package 140, so as to position the mounting device 100 and/or sensor package 140 for mounting to a mounting surface and/or surveillance of an area.

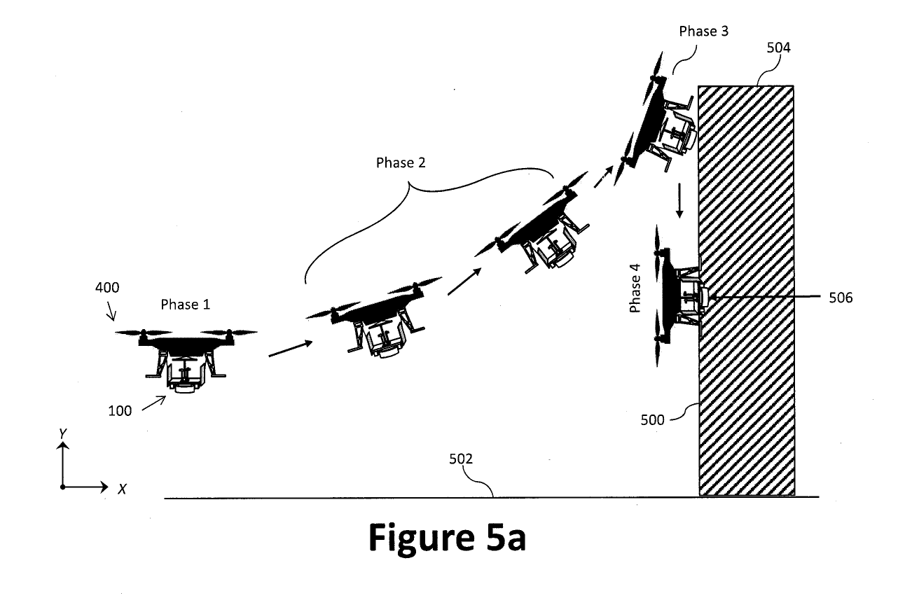

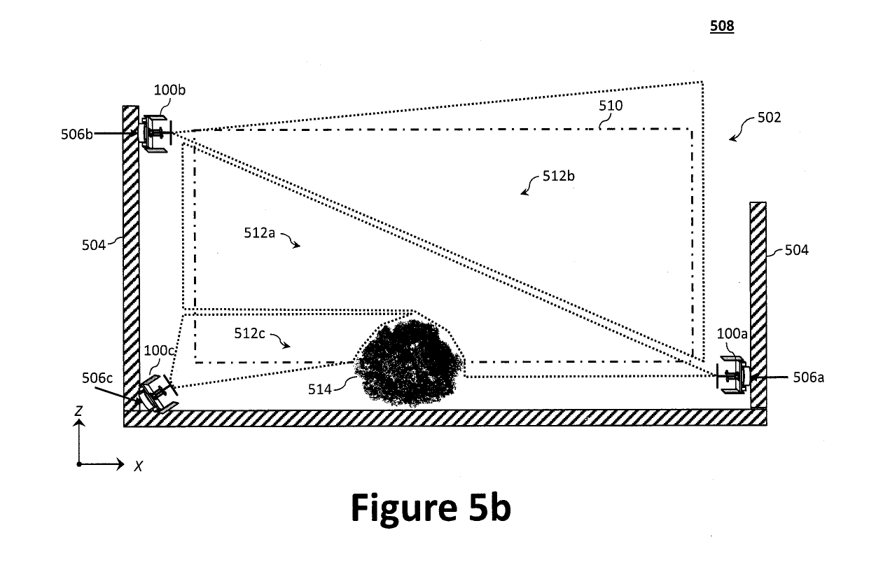

FIG. 5a illustrates an example UAV 400 positioning a mounting device 100 and associated sensor package 140 by performing a vertical landing maneuver to affix to a target landing area 506 (or another attachment location) of a mounting surface 500 of a wall 504 (or another vertical structure). As illustrated, the UAV pitches up near the target and affixes to the mounting surface 500 at the target landing area 506. The vertical landing maneuver may be generally divided into four phases. During Phase 1, the UAV 400 generates a balanced thrust to fly parallel to the ground surface 502. Phase 1 is, in effect, a normal flight mode. In Phase 1, the UAV 400 holds the mounting device 100 relatively level. During Phase 2, as the UAV 400 approaches the mounting surface 500, the UAV 400 pitches upward toward the mounting surface 500 until the UAV 400 is nearly perpendicular to the ground surface 502. At Phase 3, the UAV 400 is nearly perpendicular to the ground surface 502 and effectively enters a stall mode, at which point the UAV 400 begins to drop downward (lose altitude) toward the target landing area 506. In other words, the UAV 400 tilts to reorient itself relatively parallel to the mounting surface 500 in Phases 2 and 3.

At Phase 4 the UAV 400 is in a position proximate and/or parallel (and/or level) with mounting surface 500 (i.e., a wall) so as to enable the mounting device 100 to anchor itself to the mounting surface 500 of the wall 504 at the target landing area 506. A shock-absorbent apparatus may be employed by the UAV 400 to absorb shock at contact with the target landing area 506. Once the UAV 400 is orientated with its landing gear against the wall 504, the same affixing mechanisms disclosed are applicable here as well. For example, if the wall is a building with a smooth surface (e.g., glass, metal, etc.), the mounting/affixing mechanism may employ suction cups, bio-inspired devices, etc. While the mounting surface 500 is illustrated as perpendicular to the ground surface 502, any inclined surface (at a negative or positive degree) could work as well. In certain aspects, the mounting device 100 may be integral with the aerial vehicle (e.g., UAV 400), where the entire aerial vehicle may attach (or perch) and use its sensor payload (e.g., ISR payload) to monitor a surrounding environment.

FIG. 5b illustrates a top plan view of an example environment 508 with multiple mounting devices 100 (illustrates as first, second, and third mounting devices 100a, 100b, 100c). Each mounting device 100 in the environment 508 comprises a sensor package 140. Therefore, in certain aspects, a plurality of mounting devices 100 with sensor packages 140 can be deployed and mounted in an environment 508 to create a network of sensor packages 140. The target landing area 506 of each of the multiple mounting devices 100 (illustrated as target landing areas 506a, 506b, 506c) may be selected as a function of the location of other mounting devices 100 and/or sensor packages 140 in the environment 508.

As can be appreciated, the multiple mounting devices 100a 100b 100c may each employ a sensor package 140 that provides a known and/or finite ISR coverage 512 (illustrates as first, second, and third ISR coverages 512a, 512b, 512c). Therefore, in a situation where each sensor package 140 provides a finite ISR coverage 512 (e.g., limited in range, limited line of sight, etc.), additional sensor packages 140 may be positioned based at least in part on a known location or known ISR coverage of existing sensor packages 140 such that the location(s) of the additional sensor package(s) 140 in aggregate cover a predetermined ISR area 510. For example, as illustrated, the first, second, and third mounting devices 100a, 100b, 100c may be arranged at target landing areas 506a, 506b, 506c such that their first, second, and third ISR coverages 512a, 512b, 512c cover (substantially or entirely) the ISR area 510.

In certain aspects, additional sensor packages 140 may be positioned at a target landing area based at least in part input (e.g., information or data, such as optical data, optical data analysis, etc.) from sensor packages 140 already existing (e.g., already positioned) in the environment 508. The existing sensor packages 140 may be used to determine whether there are obstructions 514 in its way, then, based on such obstruction data, determine the location(s) for any additional sensor package(s) 140. For example, the sensor package 140 of the first mounting device 100a at the first target landing area 506a may reflect that an obstruction 514 exists, therefore the target landing area 506c for the third mounting device 100c may be selected to cover the portion of the ISR area 510 obstructed by obstruction 514 the from the perspective of the first mounting device 100a at the first target landing area 506a.

Additionally or alternatively, the locations of the target landing areas for additional sensor packages 140 may be determined by deploying a UAV configured to survey the environment and to identify how multiple sensor packages 140 can be positioned in the environment 508 to cover the ISR area 510, thereby identifying the target landing areas for each of the sensor packages 140. In certain aspects, the deploying UAV can carry multiple sensor packages 140 (each having a mounting device 100, for example).

FIGS. 6a through 6c illustrate example changes in displacement and/or compression of the gasket 112 and/or the suction cup 110, such as due to varying pressures within the cavity 114 of the suction cup 110 caused by the vacuum pump 116. FIG. 6a illustrates an initial placement of the gasket 112 and/or mounting device 100, such as when initially positioned proximate a surface (such as in phase 4 of FIG. 5a). When initially placed, the edge 130 of the gasket 112 is fully extended and/or uncompressed, making contact with the mounting surface 500. The passive adherents 126 are spaced from the mounting surface 500 and the edge 130 of the gasket 112. The positioning system 204 of the sensor package 140, the positioning system 316 of the mounting device 100, and/or the ISR payload 208 of the sensor package 140 may detect a mounting surface 500 sufficiently close to the gasket 112 to initiate the active adhering system. The vacuum pump 116 may thus be activated via a command received from the processor 214 of the sensor package 140, the processor 314 of the mounting device 100, and/or from a remote device 300 (e.g., UAV or remote operator). A negative pressure differential may be created within the cavity 114 of the suction cup 110 by the activated vacuum pump 116, creating suction within the cavity 114 and providing an adhering force through the suction cup 110, so as to anchor the mounting device 100 to the mounting surface 500.

FIG. 6b illustrates the mounting device 100 with the gasket 112 at an intermediate displacement and/or compression. An adhering force through the suction cup 110 is still sufficient to anchor the mounting device 100 to the mounting surface 500, and sufficient time has elapsed for the soft flexible spring like gasket 112 to be compressed by the vacuum force within the cavity 114 of the suction cup 110. Because of the compression, the height H of the gasket 112 in FIG. 6b is less than the height H in FIG. 6a. However, the passive adherents 126 are still spaced from the mounting surface 500, albeit less so than in FIG. 6a. The vacuum pump 116 may still be active, or it may have been deactivated to save power, with the check valve 142 substantially preventing any change in fluid pressure within the cavity 114 through the conduit 118. The check valve 142 may be positioned in line with the vacuum pump to preserve the pressure differential within the cavity 114 when the vacuum pump 116 (or another form of pressurizer) is deactivated (e.g., to save power).

The release valve 124 similarly closes the relief passage 122 to prevent any change in fluid pressure through the relief passage 122. The vacuum pump 116 may be continually activated and/or intermittently activated to maintain the intermediate displacement and/or compression of the gasket 112, depending on leakage, and/or in accordance with one or more commands from the processor 214 of the sensor package 140, a processor 314 of the mounting device 100, and/or from a remote device 300 (e.g., UAV or remote operator). In some examples, the command(s) may be based at least in part on measurements from the positioning system 204 of the sensor package 140, the positioning system 316 of the mounting device 100, and/or the ISR payload 208 of the sensor package 140.

FIG. 6c illustrates the mounting device 100 with the gasket 112 at a significant (and/or severe etc.) displacement and/or compression. The vacuum pump 116 has increased negative pressure differential within the cavity 114 of the suction cup 110 in accordance with one or more commands from the processor 214 of the sensor package 140, the processor 314 of the mounting device 100, and/or from a remote device 300 (e.g., UAV or remote operator). In some examples, the command(s) may be based at least in part on a determination that the sensor package is in a good position (which may be based at least in part on measurements of the ISR payload 208). In some examples, the commands may be based at least in part on a measurement of the remaining available power (and/or potential power) of the power source 210 of the sensor package 140 and/or power source 318 of the mounting device 100. For example, the remaining available power may be a battery level, a fuel level, a heat level (as compared to a safe operating heat level) of the power source, or some other indication of remaining available power. In any case, the vacuum pump 116 has increased the vacuum pressure within the cavity 114 to severely compress the gasket 112 to a height (H) less than in both FIGS. 6a and 6b. At such compression, the passive adherents 126 have come into contact with the mounting surface 500, thereby adhering to the surface to provide additional attachment points for the mounting device 100. Now the vacuum pump 116 may be deactivated without the mounting device 100 coming free from the mounting surface 500.

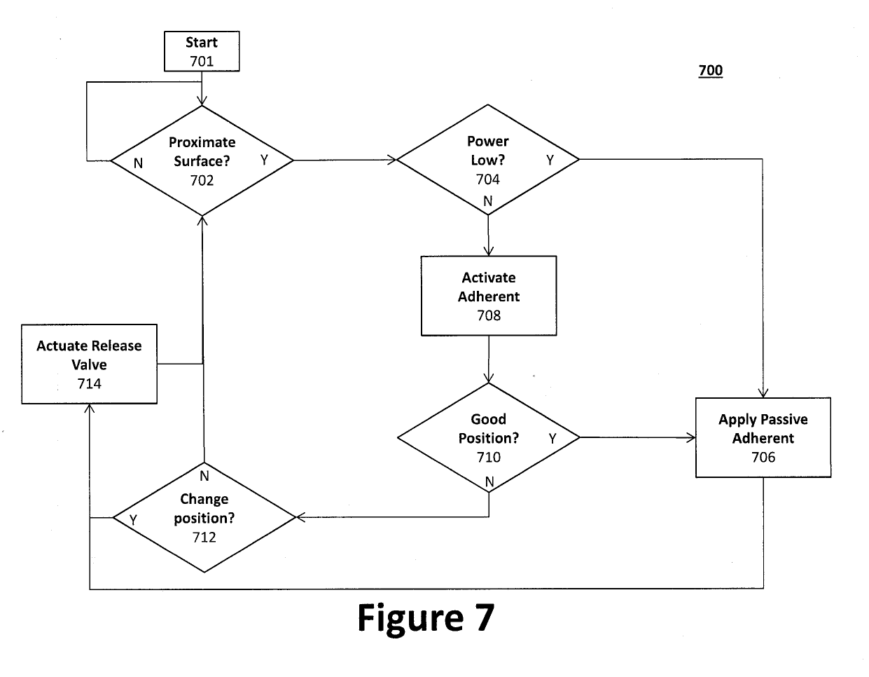

FIG. 7 illustrates a method 700 of operating the mounting device 100. The method may be implemented by the just the mounting device 100, or the mounting device 100 in conjunction with input from the sensor package 140 and/or one or more remote devices 300. The method begins at step 701. At step 702, a determination is made as to whether the mounting device 100 is sufficiently close to a suitable mounting surface 500 to activate its active adhering system. In some examples, the determination at step 702 may be made by a remote device 300 and transmitted to the mounting device 100. In some examples, the processor 214 of the sensor package 140 and/or the processor 314 of the mounting device 100 may make the determination. In some examples, the determination may be made based at least in part on surveillance data generated and/or acquired by the ISR payload 208 of the sensor package 140, and/or data generated and/or acquired by the positioning system 204 of the sensor package 140 and/or the positioning system 316 of the mounting device 100. If the determination at step 702 is that the mounting device 100 is not sufficiently close to a potentially viable mounting surface 500, then no action is taken, and step 702 may be reiterated until the mounting device 100 is sufficiently close to a suitable mounting surface 500. If the determination at step 702 is that the mounting device 100 is sufficiently close to a potentially viable mounting surface 500, the method proceeds to step 704.

At step 704, a determination may be made as to whether the power available from the power source 210 and/or power source 318 is low. This determination may involve comparing the currently available, potentially available, and/or estimated currently available and/or potentially available power to some threshold power level. The threshold power level may be stored in the memory 212 of the sensor package 140, the memory 312 of the mounting device 100, and/or may be transmitted by a remote device 300. If the currently available, potentially available, and/or estimated currently available and/or potentially available power is at, below, or sufficiently close to the threshold value, the method may proceed to step 706, where the passive adherents 126 are applied to the mounting surface 500, such as outlined above with respect to FIG. 6c. Otherwise, the method may proceed to step 708. In some examples of the method, an additional step 710 may be inserted between steps 704 and 706, where a determination is made whether the mounting device 100 is in a good position before proceeding to step 706 where the passive adherent s are applied.

At step 708, the active adherent system is activated. The vacuum pump 116 is activated to create vacuum pressure within the cavity 114 of the suction cup 110, thereby adhering the suction cup to the mounting surface 500. The vacuum pump 116 may actively maintain the right level of suction by being cycled on and off, and/or being throttled to compensate for any leakage. In some examples, the ISR payload 208 may be used to help determine potential and/or actual leakage. Data pertaining to leakage may be used to determine if and/or when to activate the vacuum pump 116, as well as an amount of vacuum pressure to apply. Based on the data, the vacuum pump 116 may be cycled on and off, and/or throttled to compensate for any leakage. The method then proceeds to step 710.

At step 710, a determination is made whether the mounting device 100 and/or sensor package 140 is in a good position to generate and/or acquire surveillance data. The surveillance data may be used to determine whether the mounting device 100 and/or sensor package 140 is placed in a good position (such that the passive adherents should be applied in step 706 for more permanent anchorage), and/or if the mounting device 100 and/or sensor package 140 should be repositioned. If the mounting device 100 and/or sensor package 140 is determined to be in a good position, the method proceeds to step 706 where passive adherents are applied, such as outlined above with respect to FIG. 6c. If too little time has passed to make this determination, or if the mounting device 100 and/or sensor package 140 is determined to not be in a good position, the method proceeds to step 712. In certain aspects, there is no need to proceed to step 714 after step 706 because the release valve may just remain closed, thereby also maintaining the vacuum (in addition to the adherent).

At step 712, a determination may be made as to whether to change the position of the mounting device 100 and/or sensor package 140. This determination may be based at least in part on whether a better position has been detected for mounting nearby (such as through surveillance data, for example), whether sufficient time has elapsed for a determination of good position in step 710, a current and/or estimated position of the mounting device 100 and/or sensor package 140, and/or a current and/or estimated position of one or more vehicles available to reposition the mounting device 100 and/or sensor package 140 (and/or a time it may take for the one or more vehicles to arrive). If a determination is made not to change position, the method proceeds to step 702, where the method repeats. If a determination is made to change position, the method proceeds to step 714.

At step 714, the release valve 124 is actuated to open the relief passage 122. This will bring the cavity 114 into fluid communication with the surrounding environment, and equalize the fluid pressure within the cavity 114 with the fluid pressure of the surrounding environment. Thus, the vacuum pressure within the cavity 114 will be removed and the suction cup 110 and/or mounting device 100 will lose its active adhering force with the mounting surface 500. This will allow the mounting device 100 to be removed from the mounting surface 500 and repositioned, such as by one or more vehicles. Afterwards, the method may proceed to step 702, where the method 700 may repeat.

It can be appreciated that aspects of the present disclosure may be implemented by hardware, software and/or a combination thereof. The software may be stored in a non-transitory machine-readable (e.g., computer-readable) storage medium, for example, an erasable or re-writable Read Only Memory (ROM), a memory, for example, a Random Access Memory (RAM, a memory chip, a memory device, or a memory Integrated Circuit (IC), or an optically or magnetically recordable non-transitory machine-readable, e.g., computer-readable, storage medium, e.g., a Compact Disk (CD), a Digital Versatile Disk (DVD), a magnetic disk, or a magnetic tape.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A mounting device for securing a sensor payload at an object, comprising:
a base configured to support the sensor payload;
a suction cup coupled to a first surface of the base, the suction cup defining a cavity that is in fluid communication with a pressurizer, wherein the pressurizer is configured to create a negative pressure within the cavity to adhere the suction cup to a mounting surface of the object;
a controller operatively coupled to the pressurizer, the controller configured to selectively activate the pressurizer to achieve a predetermined negative pressure within the cavity; and
a release valve configured to vent the cavity, thereby releasing the suction cup from the mounting surface of the object.

2. The mounting device of claim 1, further comprising a check valve positioned in line between the pressurizer and the cavity, wherein the check valve is configured to maintain the predetermined negative pressure within the cavity when the pressurizer is inactive.

3. The mounting device of claim 1, wherein the release valve is operatively coupled to the controller, the controller being configured to actuate the release valve to releases the suction cup from the mounting surface of the object.

4. The mounting device of claim 1, wherein the controller is operatively coupled with a pressure sensor configured to measure the negative pressure within the cavity.

5. The mounting device of claim 4, wherein the controller is operatively coupled to the release valve, the controller being configured to actuate the pressurizer or the release valve as a function of a measurement from the pressure sensor.

6. The mounting device of claim 1, wherein the suction cup comprises a gasket that is configured to conform to a shape or a texture of the mounting surface, thereby providing a fluid-tight seal between the suction cup and the mounting surface.

7. The mounting device of claim 1, wherein the sensor package comprises at least one sensor configured to observe a surrounding environment.

8. The mounting device of claim 7, wherein the at least one sensor is configured to determine a position of the mounting device within the surrounding environment.

9. The mounting device of claim 8, wherein the at least one sensor comprises a camera, a motion sensor, a position sensor, a proximity sensor, a pressure sensor, or an accelerometer.

10. The mounting device of claim 7, wherein the sensor package is communicatively coupled with a second sensor package in via a network.

11. The mounting device of claim 1, further comprising a coupling configured to couple releasably the mounting device to an aerial vehicle.

12. The mounting device of claim 1, further comprising a passive adherent coupled to the first surface of the base, wherein the passive adherent is configured to adhere the mounting device to the mounting surface via the base.

13. The mounting device of claim 12, wherein the passive adherent comprises a plurality of adhesive pads.

14. The mounting device of claim 12, wherein the pressurizer is coupled to a power source, wherein the controller is configured to adhere the mounting device to the mounting surface via the suction cup or the passive adherent based at least in part on a status of the power source.

15. A method for securing a sensor payload at an object using a mounting device, the method comprising:
positioning at a mounting surface a base configured to support the sensor payload, wherein a suction cup is coupled to a first surface of the base, the suction cup defining a cavity that is in fluid communication with a pressurizer;
creating, via a pressurizer, a negative pressure within the cavity to adhere the suction cup to the mounting surface of the object; and
selectively activating, via a controller, a pressurizer to achieve a predetermined negative pressure within the cavity.

16. The method of claim 15, further comprising the step of releasing the suction cup from the mounting surface of the object via a release valve configured to vent the cavity.

17. The method of claim 15, further comprising the step of determining, via one or more sensors coupled to the controller, whether the mounting device is proximate the mounting surface, wherein the negative pressure within the cavity is generated if the mounting device is proximate the mounting surface.

18. The method of claim 15, further comprising the step of determining, via the controller, whether the mounting device is positioned at a suitable position based at least in part on surveillance data acquired by the sensor package, wherein the mounting device is adhered to the mounting surface using a passive adherent if the mounting device is positioned at a suitable position.

19. The method of claim 18, wherein the mounting device is adhered to the mounting surface using the passive adherent by applying negative pressure to the cavity via the pressurizer to compress the suction cup until the passive adherent is brought into adhering contact with the mounting surface.

20. A surveillance system comprising:
a first mounting device configured to secure a first sensor payload to a first mounting surface, wherein the first mounting device comprises: a base configured to support the first sensor payload: a suction cup coupled to a first surface of the base, the suction cup defining a cavity that is in fluid communication with a pressurizer, wherein the pressurizer is configured to create a negative pressure within the cavity to adhere the suction cup to the first mounting surface; a controller operatively coupled to the pressurizer, the controller configured to selectively activate the pressurizer to achieve a predetermined negative pressure within the cavity; and a release valve configured to vent the cavity, thereby releasing the suction cup from the first mounting surface;
a second mounting device configured to secure a second sensor payload to a second mounting surface, wherein the second mounting device comprises: a base configured to support the second sensor payload: a suction cup coupled to a second surface of the base, the suction cup defining a cavity that is in fluid communication with a pressurizer, wherein the pressurizer is configured to create a negative pressure within the cavity to adhere the suction cup to the second mounting surface; a controller operatively coupled to the pressurizer, the controller configured to selectively activate the pressurizer to achieve a predetermined negative pressure within the cavity; and a release valve configured to vent the cavity, thereby releasing the suction cup from the second mounting surface; and
an aerial vehicle configured to place the second mounting device at the second mounting surface based at least in part on information from the first sensor payload.
